(19) United States
(12) Patent Application Publication
(10) Pub. No.: US 2005/0213587 A1
(43) Pub. Date: Sep. 29, 2005

(54) Apparatus and method for scheduling packets in a wireless communication system

(75) Inventors: Min-Hee Cho, Suwon-si (KR); Bong-Gee Song, Seongnam-si (KR); Kwang-Seop Eom, Soongnam-si (KR); Seung-Eun Hong, Suwon-si (KR); Hyeong-Jong Ju, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/089,616

(22) Filed: Mar. 25, 2005

(30) Foreign Application Priority Data
Mar. 26, 2004 (KR) 2004-20629

(51) Int. Cl. H04L 12/28; H04L 12/56; H04L 12/54

(52) U.S. Cl. 370/395.42; 370/395.21; 370/412; 370/428

(57) ABSTRACT

An apparatus and a method for scheduling packets in a wireless communication system. The method includes the steps of dividing a transmission deadline of the packets for a destination into a first deadline, which is an end point of the transmission deadline, and a second deadline, which is allocated before the first deadline in consideration of a transmission channel state and a quality of service (QoS) of the packets, scheduling and transmitting the packets according to transmission priorities thereof, which are determined by a predetermined scheme, before the second deadline, and scheduling and transmitting the packets according to an approaching order of the packets with respect to the first deadline, if the packets have passed through the second deadline.

### PRIORITY

This application claims the benefit under 35 U.S.C. 119(a) of an application entitled “Apparatus And Method For Scheduling Packets In A Wireless Communication System” filed with the Korean Intellectual Property Office on Mar. 26, 2004 and assigned Serial No. 2004-20629, the entire contents of which are incorporated herein by reference.

### BACKGROUND OF THE INVENTION

1. Field of the Invention

The present invention relates generally to a wireless communication system, and more particularly, to an apparatus and a method for scheduling packets in a wireless communication system.

2. Description of the Related Art P In general, a plurality of subscriber stations (SSs) communicate with a base station (BS) through a wireless shared channel in a wireless communication system. Accordingly, upon receiving the packets for the SSs, the BS transmits packets to SSs corresponding to destination addresses of the packets. The packets include timers so that the packets can be transmitted to destinations by a predetermined point of time, which is preset in the timers. Herein, an expire time of the timer is defined as a deadline time or a deadline. Therefore, the BS must determine the packet to be transmitted, packet transmission time, and the SS that will receive the packet. In the above determination of the BS, it is determined if a throughput of the wireless shared channel and a transmission delay time of corresponding traffic are satisfied.

The BS schedules the packets using a scheduler in order to support a quality of service (QoS) required by the SSs.

The SSs may have their own QoS. For example, a real time service must be ensured for the SS, which transmits and receives voice or multimedia data. Accordingly, the BS must process the voice or multimedia data of the SS prior to data of other SSs having a low-class QoS, that is, a non-real time service.

Scheduling schemes of the BS for processing the traffic packets will be described below.

First, an earliest deadline first (EDF) algorithm is used for processing the traffic packets, in which traffic packets approaching the deadline are primarily transmitted. Although the EDF algorithm is adaptable for transmitting the traffic packets through a wired network before the deadline, it does not take the wireless channel into consideration, so it is impossible to improve the throughput of the BS based on the state of the wireless channel.

Second, a proportional fairness (PF) algorithm is used for processing the traffic packets. According to the PF algorithm, the throughput of the BS can be improved by taking the state of the wireless channel of each SS into consideration regardless of the deadline. That is, the traffic packets of SSs having a wireless channel state that is superior to an average wireless channel state are primarily processed, in order to effectively improve the throughput of the BS. However, because the PF algorithm does not take the deadline into consideration, the PF algorithm cannot be used to process the traffic packets to be transmitted in real time.

As described above, the packet scheduling scheme using the EDF algorithm causes the low throughput of the BS, and the packet scheduling scheme using the PF algorithm does not effectively process the traffic packets in real time.

### SUMMARY OF THE INVENTION

Accordingly, the present invention has been designed to solve the above and other problems occurring in the prior art. An object of the present invention is to provide an apparatus and a method for scheduling packets in a wireless communication system by considering a state of a transmission channel in order to increase a packet throughput.

Another object of the present invention is to provide a scheduling apparatus and a scheduling method capable of effectively processing the packets based on a QoS of an SS in a wireless communication system.

Still another object of the present invention is to provide a scheduling apparatus and a scheduling method capable of ensuring a transmission deadline of a real time traffic packet.

To accomplish the above and other objects, according to a first aspect of the present invention, there is provided a method of scheduling packets in a wireless communication system. The method includes the steps of: dividing a transmission deadline of the packets for a destination into a first deadline, which is an end point of the transmission deadline, and a second deadline, which is preset before the first deadline by considering a transmission channel state and a quality of service (QoS) of the packets; scheduling and transmitting the packets according to transmission priorities thereof, which are determined by a predetermined scheme, before the second deadline; and scheduling and transmitting the packets according to an approach of the packets with respect to the first deadline if the packets have passed through the second deadline.

According to a second aspect of the present invention, there is provided n apparatus for scheduling packets in a wireless communication system. The apparatus includes: a buffer for storing the packets; and a scheduler capable of dividing a transmission deadline of the packets for a destination into a first deadline, which is an end point of the transmission deadline, and a second deadline, which is preset before the first deadline by taking a transmission channel state and a quality of service (QoS) of the packets into consideration. The scheduler schedules and transmits the packets stored in the buffer according to transmission priorities thereof, which are determined by a predetermined scheme, before the second deadline, and the scheduler schedules and transmits the packets according to an approach of the packets with respect to the first deadline if the packets have passed through the second deadline.

### BRIEF DESCRIPTION OF THE DRAWINGS

The above and other objects, features, and advantages of the present invention will be more apparent from the following detailed description taken in conjunction with the accompanying drawings, in which:

FIG. 1 illustrates a time axis illustrating processing steps for a predetermined packet in a wireless communication system according to an embodiment of the present invention;

FIG. 2 is a schematic view illustrating a structure for processing a packet in a wireless communication system according to an embodiment of the present invention; and

FIG. 3 is a flowchart illustrating a procedure of transmitting a packet by a scheduler in a wireless communication system according to an embodiment of the present invention.

### DETAILED DESCRIPTION OF THE PREFERRED EMBODIMENT

Preferred embodiments of the present invention will be described in detail herein below with reference to the accompanying drawings. In the following description of the present invention, a detailed description of known functions and configurations incorporated herein will be omitted when it may obscure the subject matter of the present invention.

The present invention provides a scheduling apparatus and method, in which the traffic packet of the BS is processed in the wireless communication system in consideration of the QoS of the SS and the transmission channel state, thereby improving the throughput of the BS and ensuring the deadline, i.e., a maximum transmission delay time of the traffic packet. More specifically, when processing the traffic packet, the final transmission deadline of the packet for the destination is divided into a soft deadline and a hard deadline in such a manner that the packets, which have passed through the soft deadline, can be transmitted prior to packets, which do not pass through the soft deadline. The packets, which do not pass through the soft deadline, are transmitted in consideration of an approach of the packets to the soft deadline, the transmission channel state, and the QoS level of the SS, thereby effectively processing the traffic packets.

However, prior to describing the present invention, it should be noted that the packet has a transmission deadline for the destination, i.e., the packet must be transmitted to the destination before the deadline. However, as described above in the conventional art, if the traffic packets are processed in consideration of only the deadline, without considering the transmission channel state, the throughput of the packets may be lowered. However, if the traffic packets are processed in consideration of only the transmission channel state, without considering the deadline, real time voice or real time packets used for a multimedia service may not be effectively processed.

Accordingly, in order to solve the above and other problems, the present invention processes the packets by dividing the soft deadline and the hard deadline to a time axis.

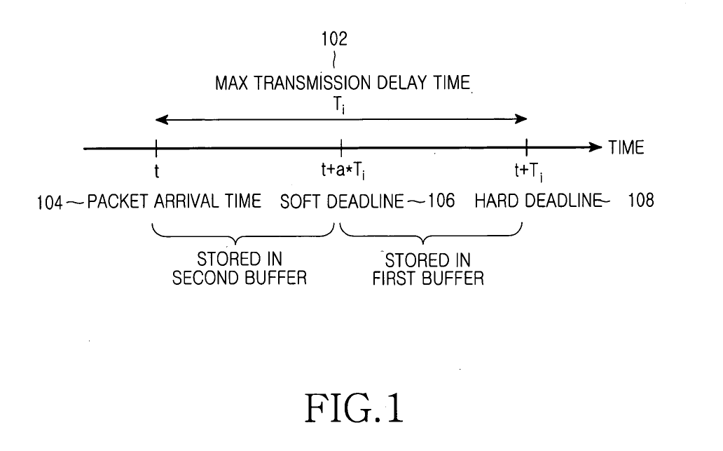

FIG. 1 illustrates the time axis illustrating the processing steps for a predetermined packet in a wireless communication system according to an embodiment of the present invention. In FIG. 1, the description will be made in relation to the soft deadline and the hard deadline. The hard deadline is to an end point of transmission time allocated to the packet arrived at a scheduler for the destination. The hard deadline may vary depending on the QoS level of the packet. The soft deadline may vary depending on the QoS level of the packet and the transmission channel state.

For instance, if a packet arrives at the scheduler at a predetermined point of time t and a predetermined hard deadline is set to t+5, the packet must be transmitted to the destination within a period of time between t and t+5. According to the present invention, the soft deadline t+3 is set between the packet arrival time t and the deadline t+5 in consideration of the transmission channel state and the QoS level of the packet. Therefore, in the period of time between t and t+3, the packets are scheduled in consideration of the transmission priority of the packets, in which the transmission priority is determined according to Equations (1) and (2), below.

In addition, in the period of time between t+3 and t+5, the packets approaching the hard deadline are primarily transmitted to the destination.

After the scheduler recognizes the hard deadline, which is preset in the packet, it schedules the packets by a second scheduling algorithm in a period of time between the packet arrival time and the soft deadline and it schedules the packets, which have passed through the soft deadline, by a first scheduling algorithm. Herein, it should be noted that the first scheduling algorithm may operate prior to the second scheduling algorithm, thereby primarily transmits packets approaching the hard deadline to the destination.

Referring to FIG. 1, the scheduler must transmit the traffic packet to the destination within a maximum transmission delay time Tᵢ 102. If the packet arrives at the scheduler at a time point t 104, the packet must be transmitted to the destination before the hard deadline t+Tᵢ 108. In addition, if a soft deadline 106 is set to t+a×Tᵢ, a value of the parameter a is a weight value having a range between 0≦a≦1, which is determined according to a kind of service connections and a connection service charge when establishing a call between the scheduler and the destination. For example, the weight value a of the voice connection may be different from the weight value a of the multimedia connection. In addition, among the voice connections, the weight value a of a voice connection paying a high service charge may be smaller than that of other voice connections. That is, the packet having the small weight value a has the transmission priority as compared with packets having larger weight value.

If the deadline is divided into the soft deadline 106 and the hard deadline 108, the packets remaining between the packet arrival time 104 and the soft deadline 106 are stored in a second buffer, which is a soft deadline buffer. In addition, packets remaining between the soft deadline 106 and the hard deadline 108 are stored in a first buffer, which is a hard deadline buffer. Accordingly, the scheduler primarily transmits the packets stored in the first buffer to the destination, and then, transmits the packets stored in the second buffer to the destination.

Although the present invention has been described that the packets are scheduled using the first and second buffers, it is also possible to integrate the first and second buffers into one buffer in order to schedule the packets.

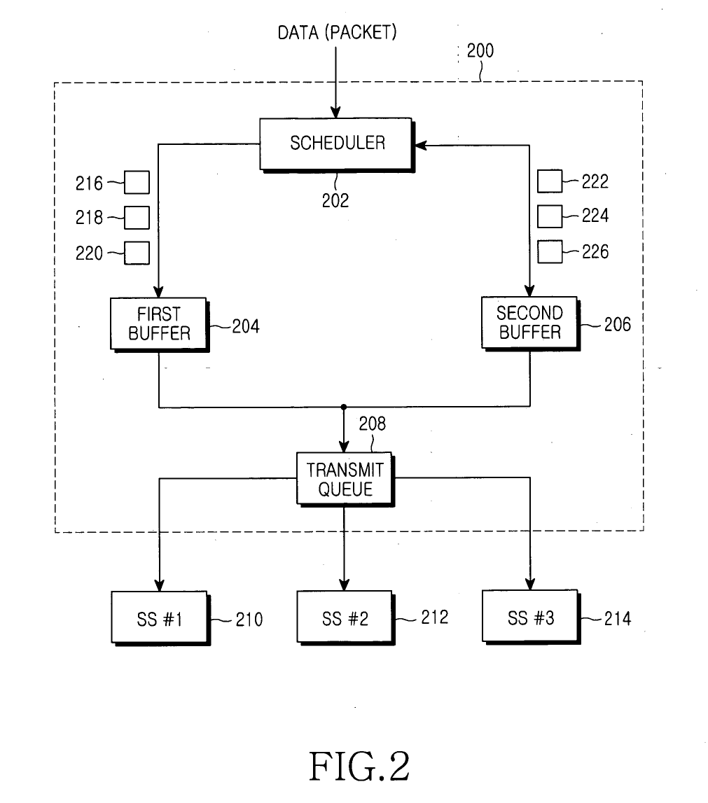

FIG. 2 is a schematic view illustrating a structure for processing a packet in a wireless communication system according to an embodiment of the present invention. Referring to FIG. 2, a BS 200 includes a scheduler 202 for scheduling packets, first and second buffers 204 and 206 for storing packets, and a transmit queue 208, which is a buffer for transmitting packets stored in the first and second buffers 204 and 206 to SSs 210, 212, and 214.

Upon receiving the packets, the scheduler 202 stores the packets in the second buffer 206, i.e., in the soft deadline buffer.

In FIG. 2, reference numerals 222, 224, and 226 represent packets that do not pass through the soft deadline t+a×Tᵢ 106 illustrated in FIG. 1. If the packets 222, 224 and 226 are not transmitted to the destination, even if packets 222, 224, and 226 have passed through the soft deadline t+a×Tᵢ 106, the scheduler 202 moves packets 222, 224, and 226 from the second buffer 206 to the first buffer 204, in order to primarily process packets 222, 224, and 226. However, if there are no packets stored in the first buffer 204, the scheduler 202 moves the packets stored in the second buffer 206 to the transmit queue 208, in order to transmit the packets stored in the second buffer 206 to the corresponding SSs.

In FIG. 2, reference numerals 216, 218, 220 represent packets remaining between the soft deadline t+a×Tᵢ 106 and the hard deadline t+Tᵢ 108, which is stored in the first buffer 204.

The scheduler 202 performs the first scheduling algorithm for scheduling the packets stored in the first buffer 204 and the second scheduling algorithm for scheduling the packets stored in the second buffer 206.

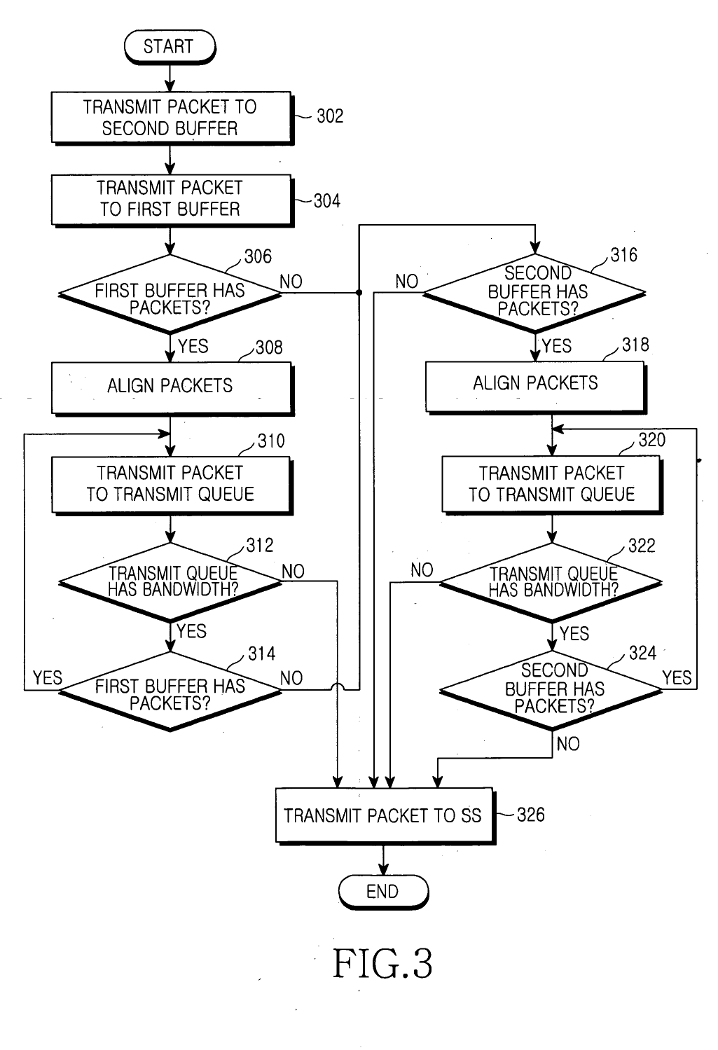

FIG. 3 is a flowchart illustrating a procedure of transmitting the packets by means of the scheduler in a wireless communication system according to an embodiment of the present invention. More specifically, FIG. 3 illustrates an operation of the scheduler 202 for transmitting the packets to the destination through the first scheduling algorithm or the second scheduling algorithm.

Referring to FIG. 3, steps 306 to 314 represent the procedure according to the first scheduling algorithm and steps 316 to 324 represent the procedure according to the second scheduling algorithm.

Packets received in the scheduler 202 are transmitted to the second buffer 206 in step 302. The scheduler 202 selects packets, which have passed through the soft deadline, from among packets stored in the second buffer 206 and transmits the packets to the first buffer 204 in step 304. Thereafter, the scheduler 202 determines if there are packets in the first buffer 204 in step 306. If the first buffer 204 has the packets, step 308 is performed. However, if there are no packets in the first buffer 204, step 316 is performed.

In step 308, the scheduler 202 aligns the packets stored in the first buffer 204 according to an approaching order of the packets with respect to the hard deadline. The scheduler 202 selects a packet aligned near by the hard deadline from among packets stored in the first buffer 204 and transmits the packet to the transmit queue 208 in step 310. In step 312, the scheduler 202 determines if the transmit queue 208 has bandwidths for packet transmission. If it is determined in step 312 that the transmit queue 208 has bandwidths for packet transmission, step 314 is performed. Otherwise, step 326 is performed in order to transmit packets of the transmit queue 208 to corresponding SSs.

In step 314, the scheduler 202 determines if the first buffer 204 still has packets. If it is determined in step 314 that the first buffer 204 still has packets, the procedure returns to step 310. Otherwise, step 316 is performed.

In step 316, the scheduler 202 determines if the second buffer 316 has packets. If the second buffer 316 has the packets, step 318 is performed. Otherwise, step 326 is performed in order to transmit the packets of the transmit queue 208 to corresponding SSs.

In step 318, the scheduler 202 aligns the packets stored in the second buffer 206 according to a predetermined order obtained through Equations (1) and (2), which will be described below. The scheduler 202 transmits packets stored in the second buffer 206 to the transmit queue 208 according to the priority of the packets in step 320. In step 322, the scheduler 202 determines if the transmit queue 208 has bandwidths for packet transmission. If the transmit queue 208 has bandwidths for packet transmission, step 324 is performed. In step 324, the scheduler 324 determines if the second buffer 206 has the packets. If it is determined in step 324 that the second buffer 206 has the packets, step 320 is again performed. Otherwise, step 326 is performed.

Hereinafter, the description will be made in relation to packets with reference to Table 1, in which the packets must be transmitted from corresponding frames per each connection according to the first and second scheduling algorithms.

TABLE 1

| | [t, t + f] | [t + f, t + 2f] | [t + 2f, t + 3f] | [t + 3f, t + 4f] |
|---|---|---|---|---|
| Connection I | # Nᵢ[t, t + f] | * Nᵢ[t + f, t + 2f] | * Nᵢ[t + 2f, t + 3f] | * Nᵢ[t + 3f, t + 4f] |
| Connection j | # Nⱼ[t, t + f] | # Nⱼ[t + f, t + 2f] | # Nⱼ[t + 2f, t + 3f] | * Nⱼ[t + 3f, t + 4f] |
| Connection k | # Nₖ[t, t + f] | # Nₖ[t + f, t + 2f] | * Nₖ[t + 2f, t + 3f] | * Nₖ[t + 3f, t + 4f] |

#; packets which pass through the soft deadline
*; packets which do not pass through the soft deadline

Table 1 shows packets to be transmitted from corresponding frames or from previous frames per each connection. Herein, Nᵢ[t, t+f] represents a sum of bits of packets having the hard deadline in a range between t+f and t+2f. That is, among packets of connection i, packets having Nᵢ[t, t+f] must be transmitted from a [t, t+f] frame or from a previous frame thereof. Accordingly, the scheduler schedules and transmits the packets in the order of Nᵢ[t, t+f], Nⱼ[t, t+f], Nₖ[t, t+f], Nⱼ[t+f, t+2f], Nₖ[t+f, t+2f], and Nⱼ[t+2f, t+3f] packets through the first scheduling algorithm. Thereafter, the scheduler transmits remaining packets through the second scheduling algorithm in consideration of the priority of the packets.

If the transmit queue still has the bandwidths for packet transmission even if packets of the first buffer, which have passed through the soft deadline, have been completely scheduled, the scheduler performs the second scheduling algorithm with respect to the packets, which do not pass through the soft deadline. Equations (1) and (2) are used to determine the transmission priority of the packets.

$$priority ( i ) = ( - log {δ}_{i} ) \cdot \frac{{W}_{i} ( t )}{{T}_{i}} \cdot \frac{{γ}_{i} ( t )}{{\overline{γ}}_{i}} \qquad ( 1 )$$

In Equation (1), priority (i) represents the transmission priority of the packet i stored in the second buffer. The packet has a higher transmission priority as a value of the priority (i) increases. δᵢ represents the probability of a deadline violation of the packet i, and Wᵢ(t) represents a delay time of the packet i at a time t, which is obtained by subtracting a packet arrival time from a present time. Tᵢ represents a maximum transmission delay time required for the packet i, and a parameter γᵢ(t) represents a wireless channel transmission rate of the packet i at the time t. In addition, \overline{γ}ᵢ represents an average wireless channel transmission rate in a connection including the packet i. The scheduler aligns the packets, which do no pass through the soft deadline, in the order of priorities thereof based on Equation (1) to transmit packets according to the priorities thereof.

The packet has a higher priority as a ratio of the delay time to the maximum transmission delay time

$$( \frac{{W}_{i} ( t )}{{T}_{i}} )$$

and a ratio of the wireless channel transmission rate to the average wireless channel transmission rate

$$\frac{{γ}_{i} ( t )}{{\overline{γ}}_{i}}$$

become increases. That is, if the packets have the same delay time, a packet having a channel state superior to the average channel state may have a higher transmission priority, so that the throughput can be improved.

In addition, if the packets have the channel states identical to the average channel state, a packet having a higher ratio of the delay time to the maximum transmission delay time may have a higher transmission priority, so it is adaptable for real time packet transmission.

Because (−log δᵢ) increases as δᵢ reduces, a value of priority (i) will increase as δᵢ is reduces. Herein, a value of δᵢ may vary depending on the kind of the connections. Even in the same connection, the value of δᵢ may vary depending on QoS levels. δᵢ is a parameter for allocating the priority to the packets according to the kind of connections and the QoS levels.

$$priority ( i ) = {γ}_{i} \frac{{γ}_{i} ( t )}{{\overline{γ}}_{i}} exp ( \frac{{α}_{i} {W}_{i} ( t ) - \overline{α W}}{1 + \sqrt{\overline{α W}}} ) \qquad ( 2 )$$

In Equation (2), the priority (i) represents the transmission priority of the packet i stored in the second buffer. The packet has a higher transmission priority as a value of the priority (i) increases. γᵢ and αᵢ are positive constants in which γᵢ is a weight with respect to Wᵢ(t), which may vary according to the kind of the connection and QoS levels of the connections. Herein, Wᵢ(t) in Equation (2) is the same as Wᵢ(t) in Equation (1). αᵢWᵢ(t) represents a transmission delay time of the packet i, which can be obtained by multiplying a present time t by a weight αᵢ. \overline{αW} represents an average value of the parameter αᵢWᵢ(t) of the packets waiting for the scheduling process. Accordingly, as a value of (αᵢWᵢ(t−\overline{αW}) in Equation (2) increases, the average transmission delay time of the packet i becomes larger than the average transmission delay time of the packets.

Equation (2) is used for allocating the higher transmission priority to the packets having the larger transmission delay time by comparing a predetermined packet with other packets. According to Equations (1) and (2), if the present channel, through which the predetermined packet is transmitted, has a transmission rate that is higher than a transmission rate of the average channel or the predetermined packet is aligned near to the hard deadline, the predetermined packet has a higher transmission priority.

As described above, according to the present invention, the scheduler processes the packets to be transmitted to the destination in the wireless communication system and divides the deadline allocated to each packet into the soft deadline and the hard deadline. Therefore, packets having superior wireless channel states and packets aligned next to the hard deadline are processed prior to packets that do not pass through the soft deadline. In addition, packets aligned next to the hard deadline are selected from packets that have passed through the soft deadline, in such a manner that the packets can be primarily processed, thereby improving the throughput of the BS. In addition, it is also possible to transmit the real time packets before the hard deadline.

While the present invention has been shown and described with reference to certain preferred embodiments thereof, it will be understood by those skilled in the art that various changes in form and details may be made therein without departing from the spirit and scope of the present invention as defined by the appended claims.

1. An apparatus for scheduling packets in a wireless communication system, the apparatus comprising:
at least one buffer for storing the packets; and
a scheduler for dividing a transmission deadline of the packets for a destination into a first deadline, which is an end point of the transmission deadline, and a second deadline, which is preset before the first deadline in consideration of a transmission channel state and a quality of service (QoS) of the packets,
wherein the scheduler schedules and transmits the packets stored in the at least one buffer according to transmission priorities thereof, which are determined by a predetermined scheme, before the second deadline, and the scheduler schedules and transmits the packets according to an approaching order of the packets with respect to the first deadline if the packets have passed through the second deadline.

2. The apparatus as claimed in claim 1, wherein the scheduler determines the priorities of the packets in consideration of the approaching order of the packets with respect to the first deadline or the transmission channel state, before the second deadline.

3. The apparatus as claimed in claim 2, wherein the scheduler determines a higher priority to a packet aligned closer the first deadline.

4. The apparatus as claimed in claim 2, wherein the scheduler determines a higher priority to a packet having a superior transmission channel state.

5. The apparatus as claimed in claim 1, wherein the scheduler allocates the priority in such a manner that a packet, which has passed through the second deadline, has a higher priority than a packet that does not pass through the second deadline.

6. A method of scheduling packets in a wireless communication system, the method comprising the steps of:
dividing a transmission deadline of the packets for a destination into a first deadline, which is an end point of the transmission deadline, and a second deadline, which is preset before the first deadline in consideration of a transmission channel state and a quality of service (QoS) of the packets;
scheduling and transmitting the packets according to transmission priorities thereof, which are determined by a predetermined scheme, before the second deadline; and
scheduling and transmitting the packets according to an approaching order of the packets with respect to the first deadline, if the packets have passed through the second deadline.

7. The method as claimed in claim 6, wherein the predetermined scheme is determined in consideration of the approaching order of the packets with respect to the first deadline or the transmission channel state.

8. The method as claimed in claim 7, wherein a higher priority is determined to a packet aligned closer the first deadline.

9. The method as claimed in claim 7, wherein a higher priority is determined to a packet having a superior transmission channel state.

10. The method as claimed in claim 6, wherein a packet that passes through the second deadline, has a higher priority than a packet that does not pass through the second deadline.
